(19) United States
(12) Patent Application Publication
(10) Pub. No.: US 2026/0141758 A1
(43) Pub. Date: May 21, 2026

(54) VEHICLE CHASSIS OPERATION VISUALIZATION METHOD, APPARATUS, AND DISPLAY DEVICE

(71) Applicant: HL MANDO CORPORATION, Gyeonggi-do (KR)

(72) Inventors: Byungwook YOO, Gyeonggi-do (KR); Yunsoo JIN, Gyeonggi-do (KR)

(21) Appl. No.: 19/390,451

(22) Filed: Nov. 14, 2025

(30) Foreign Application Priority Data
Nov. 15, 2024 (KR) 10-2024-0163508
Nov. 10, 2025 (KR) 10-2025-0168404

(51) Int. Cl. G07C 5/12; G07C 5/08

(52) U.S. Cl. CPC G07C 5/12; G07C 5/0825

(57) ABSTRACT

A vehicle motion visualization method is characterized by including a step of displaying a vehicle model and a step of changing at least one graphic element of the vehicle model to visually represent a state change of a chassis component of the vehicle, including a brake device, based on operation information reflecting braking response characteristics of the chassis component, wherein the operation information includes at least one of a braking force of the brake device, a brake pressure, or a displacement of a brake pedal.

### CROSS-REFERENCE TO RELATED APPLICATION(S)

This application is based on and claims priority under 35 U.S.C. § 119 to Korean Patent Application No. 10-2024-0163508, filed on Nov. 15, 2024, and Patent Application No. 10-2025-0168404, filed on Nov. 10, 2025, in the Korean Intellectual Property Office, the disclosure of which is incorporated by reference herein in its entirety.

### BACKGROUND

### 1. Field

The present disclosure relates to a method, an apparatus, and a display device for visualizing operations of vehicle chassis.

### 2. Description of the Related Art

As vehicles have become increasingly advanced and modernized, consumers'primary purchasing considerations extend beyond mere mobility. In response to this shift in consumer trends, automotive manufacturers are appealing to consumers by providing in-vehicle infotainment on vehicle displays that goes beyond simple information presentation to incorporate elements of entertainment.

Currently, most infotainment systems primarily provide peripheral elements such as climate control operation during driving, media playback, and driving status or environment information. In contrast, key information related to vehicle dynamics—such as steering, braking, and suspension—is not presented as another central axis of the user interface that drivers or passengers can intuitively see and experience.

### SUMMARY

According to one embodiment, a vehicle chassis operation visualization method comprises: displaying a vehicle model; and, based on operation information of at least one chassis component among a steering device, a brake device, and a suspension device, changing at least one graphic element of the vehicle model to visually indicate a state change of the chassis component.

In the vehicle chassis operation visualization method according to an embodiment of the present invention, the graphic element includes at least one of transparency, color, brightness, contrast, and animation effects.

The state change of the chassis component in the vehicle operation visualization method according to an embodiment of the present invention includes at least one of the steering angle of the steering device, the braking force of the brake device, or the stroke amount of the suspension device.

In the vehicle chassis operation visualization method according to an embodiment of the present invention, the method further comprises displaying, on a display, a warning color or a visual emphasis effect based on the state change of the chassis component being equal to or greater than a preset threshold.

In the vehicle chassis operation visualization method according to an embodiment of the present invention, the act of changing at least one graphic element of the vehicle model for display includes changing a transparency of the vehicle model so that the vehicle model becomes transparent, based on the state change of the chassis component being equal to or greater than a preset threshold, and displaying the changed vehicle model.

In the vehicle operation visualization method according to an embodiment of the present invention, the step of displaying by changing at least one of the graphic elements of the vehicle model includes displaying by changing the transparency of the vehicle model to make it opaque based on the state change of the chassis component being restored below a preset threshold.

The vehicle chassis operation visualization method according to an embodiment of the present invention further comprises, based on the state change of the chassis component being at least a preset threshold, displaying a model of the chassis component.

In the vehicle chassis operation visualization method according to an embodiment of the present invention, the method further comprises, based on the state change of the chassis component being restored to less than the preset threshold, removing the chassis component model of the chassis component.

The vehicle operation visualization method according to an embodiment of the present invention further comprises: a step of acquiring operation data from at least one chassis component among the steering device, brake device, and suspension device of the vehicle; and a step of generating operation information of the at least one chassis component based on the operation data.

In the vehicle chassis operation visualization method according to an embodiment of the present invention, a road surface condition of the vehicle is estimated, and, in response to the estimated road surface condition, a visual effect of a floor surface of the vehicle model or a portion of a vehicle body is changed for display.

The vehicle operation visualization method according to an embodiment of the present invention includes that the operation information of the brake device comprises at least one of the braking force, brake pressure, or brake pedal displacement of the brake device.

According to an embodiment of the present invention, the vehicle operation visualization method displays a graphic element corresponding to the braking force of the brake device to visually indicate the braking state for each wheel of the vehicle model, wherein the graphic element is displayed using at least one of color change, brightness adjustment, or luminous animation.

The vehicle operation visualization method according to an embodiment of the present invention displays a warning color or flashing effect on the corresponding wheel of the vehicle model based on the braking force of the brake device being above a preset threshold value.

The vehicle operation visualization method according to an embodiment of the present invention visually distinguishes and displays the difference in braking force between the front and rear wheels of the vehicle model in response to the braking force distribution of the brake device.

The vehicle operation visualization method according to an embodiment of the present invention displays a predefined warning graphic element on the corresponding wheel or body area of the vehicle model based on the braking force control system of the brake device corresponding to the operating state of at least one of ABS, ESC, or TCS.

A vehicle operation visualization device according to an embodiment of the present invention for solving the above technical problem comprises: a memory; and a processor connected to said memory, wherein said processor displays a vehicle model and, based on operational information of at least one chassis component among the vehicle's steering device, brake device, and suspension device, visually displays changes in the state of said chassis component by modifying and displaying at least one graphic element of said vehicle model.

The processor according to an embodiment of the present invention visually indicates the state change of the chassis component by altering at least one of the transparency, color, brightness, contrast, or animation effect among the graphic elements.

According to an embodiment of the present invention, the processor modifies the graphic element based on at least one of the steering angles of the steering device, the braking force of the brake device, or the stroke amount of the suspension device, in response to a state change of the chassis component.

According to an embodiment of the present invention, the processor is configured to control the display of a warning color or a visual emphasis effect on the display when the state change of the chassis component is equal to or greater than a preset threshold.

According to another embodiment of the present invention for solving the above technical problem, the display device displays at least one graphic element of the vehicle model by changing it to visually indicate a state change of at least one chassis component, based on operational information of at least one chassis component among the vehicle's steering device, brake device, and suspension device.

According to another embodiment of the present invention, a vehicle chassis operation visualization method may include: generating chassis motion information, including at least one of steering state information, suspension state information, brake state information, and powertrain information, by using chassis component data of the vehicle; and generating motion graphics for a virtual modeled vehicle corresponding to the vehicle by using the chassis motion information.

According to another embodiment of the present invention, the step of generating the motion graphics in the vehicle chassis operation visualization method may include changing the transparency of a body of the virtual modeled vehicle in response to the chassis motion information.

According to another embodiment of the present invention, the step of generating the motion graphics in the vehicle chassis operation visualization method may include changing the transparency of the body of the virtual modeled vehicle when a motion change is detected in a wheel of the vehicle, in response to the chassis motion information.

In another embodiment of the vehicle motion visualization method according to the present invention, the step of generating motion graphics may create visual effects on the wheels of the virtual modeling vehicle corresponding to the wheels of the actual vehicle experiencing motion changes.

In another embodiment of the vehicle motion visualization method according to the present invention, the step of generating motion graphics may change the steering angle of the front or rear wheels of the virtual modeling vehicle in response to steering state information.

In another embodiment of the present invention, the step of generating motion graphics for the vehicle motion visualization method may create visual effects on the wheel whose steering angle changes, whether it be the front wheel or rear wheel of the virtual modeling vehicle.

The step of generating motion graphics for the vehicle motion visualization method according to another embodiment of the present invention may generate different visual effects on the front and rear wheels when the front and rear wheels of the virtual modeling vehicle change in opposite directions.

In another embodiment of the present invention, the step of generating motion graphics for the vehicle operation visualization method may include generating virtual path guidance information on the bottom surface of the virtual modeling vehicle when changing the steering angle of the front or rear wheels of the virtual modeling vehicle.

In another embodiment of the vehicle operation visualization method according to the present invention, the path guidance information may be displayed as a virtual guidance line centered on the wheel whose steering angle is changed.

In another embodiment of the present invention, the step of generating motion graphics for the vehicle operation visualization method may generate a visual alarm or warning sound when the steering angle of the rear wheels of the virtual modeling vehicle changes.

In another embodiment of the present invention, the step of generating motion graphics for the vehicle operation visualization method may include changing the height of each of the multiple wheels of the virtual modeling vehicle in response to the suspension status information.

In another embodiment of the vehicle motion visualization method according to the present invention, the suspension status information includes the impact force input to at least one of the multiple wheels of the vehicle, and the step of generating the motion graphics may change the height of each of the multiple wheels of the virtual modeling vehicle corresponding to the impact force.

In another embodiment of the present invention, the step of generating motion graphics for the vehicle operation visualization method may include estimating road surface condition information corresponding to the impact force and modifying the bottom surface of the virtual modeling vehicle in response to said road surface condition information.

In another embodiment of the present invention, the step of generating motion graphics for the vehicle operation visualization method may create visual effects on the suspension of wheels whose height has changed beyond a predetermined threshold among the multiple wheels of the virtual modeling vehicle.

In another embodiment of the vehicle operation visualization method according to the present invention, the chassis data may include at least one of the vehicle's steering data, suspension data, brake data, and powertrain data, and may further include a step of acquiring the chassis data via the vehicle's internal communication network.

In another embodiment of the present invention, the acquisition step of the vehicle operation visualization method may acquire the chassis data via at least one of the CAN, LIN, FlexRay, or Ethernet communication protocols.

A vehicle operation visualization method according to another embodiment of the present invention displays a vehicle model and a wheel model; displaying a chassis model that includes at least one of a steering model, a suspension model, a brake model, and a powertrain model of the vehicle based on at least one of the steering state information, suspension state information, brake state information, and powertrain state information of the vehicle; and displaying the chassis model corresponding to a state change in at least one of the steering, suspension, brakes, and powertrain.

According to another embodiment of the present invention, the vehicle operation visualization method disappears based on the restoration of at least one state among the steering, suspension, brakes, and powertrain of the vehicle.

According to another embodiment of the present invention, the vehicle operation visualization method displays the chassis model based on at least one value indicating a state change in the vehicle's steering, suspension, brakes, or powertrain being equal to or above a threshold value.

According to another embodiment of the present invention, the vehicle operation visualization method causes the chassis model to disappear based on a value indicating a change in the state of at least one of the vehicle's steering, suspension, brakes, and powertrain decreasing below a threshold value.

According to another embodiment of the present invention, the vehicle operation visualization method changes the transparency of the vehicle model based on a change in the state of at least one of the steering, suspension, brakes, and powertrain of the vehicle.

According to another embodiment of the present invention, the vehicle operation visualization method makes the vehicle model transparent based on the value indicating a state change in at least one of the steering, suspension, brakes, and powertrain of the vehicle being equal to or greater than a threshold value.

According to another embodiment of the present invention, the vehicle operation visualization method displays the chassis model, which includes the steering model, based on the value indicating the change in the steering state of the vehicle being at or above a threshold value.

According to another embodiment of the present invention, the vehicle operation visualization method displays visual effects on the wheel model based on changes in the steering state of the vehicle.

Another vehicle motion visualization method according to the present invention displays the steering angle of the wheel model based on changes in the steering state of the vehicle.

Another vehicle motion visualization method according to the present invention displays the path information of the vehicle based on changes in the steering state of the vehicle.

According to another embodiment of the present invention, a vehicle operation visualization method displays a chassis model including the suspension model based on a value indicating a change in the state of the vehicle's suspension being above a threshold value.

According to another embodiment of the present invention, the vehicle motion visualization method displays the vertical movement of the wheel model based on changes in the state of the vehicle's suspension.

According to another embodiment of the present invention, the vehicle motion visualization method displays information indicating the damping force of the suspension based on changes in the state of the vehicle's suspension.

According to another embodiment of the present invention, the vehicle operation visualization method displays the chassis model, which includes the brake model, based on the value indicating the change in the vehicle's brake status being at or above a threshold value.

According to another embodiment of the present invention, the vehicle operation visualization method displays information indicating the braking force of the vehicle's brakes based on changes in the brake status.

According to another embodiment of the present invention, the vehicle operation visualization method estimates the road surface condition and modifies the bottom surface of the vehicle model in response to said road surface condition.

According to another embodiment of the present invention, the vehicle motion visualization method acquires at least one of the steering state information, suspension state information, brake state information, and powertrain state information of the vehicle via the vehicle's internal communication network.

According to another embodiment of the present invention, the vehicle motion visualization device includes a memory and a processor connected to the memory, wherein the processor displays a vehicle model and a wheel model; and displays a chassis model including at least one of a steering model, a suspension model, a brake model, and a powertrain model of the vehicle based on at least one of the steering status information, suspension status information, brake status information, and powertrain status information of the vehicle, wherein the chassis model corresponding to a change in the status of at least one of the steering, suspension, brakes, and powertrain.

A storage medium according to another embodiment of the present invention displays a vehicle model and a wheel model; and includes displaying a chassis model that includes at least one of the steering model, suspension model, brake model, and powertrain model of the vehicle based on at least one of the steering state information, suspension state information, brake state information, and powertrain state information of the vehicle, and storing a command on a computer-readable storage medium to display the chassis model corresponding to at least one state change of the steering, suspension, brakes, and powertrain of the vehicle; and a computer-readable storage medium storing a command to cause the chassis model to be displayed in response to a state change in at least one of the steering, suspension, brakes, and powertrain of the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram showing the configuration of a vehicle operation visualization device according to one embodiment;

FIG. 2 is a block diagram showing the configuration of the sensor device according to an embodiment;

FIG. 3 is a block diagram illustrating a configuration for display and control of a brake device according to an embodiment of the present invention;

FIG. 4 is a block diagram illustrating the configuration of a display device according to another embodiment;

FIG. 5 illustrates an initial screen provided in a user interface displayed on the display device during driving of a vehicle, according to another embodiment;

FIG. 6 illustrates a user interface that intuitively indicates a brake operation state according to an embodiment of the present invention;

FIGS. 7 and 8 illustrate user interfaces that intuitively indicate, respectively, an ABS operation state and a TCS operation state on a display device during vehicle driving, according to an embodiment of the present invention;

FIG. 9 illustrates a user interface that intuitively indicates a visual effect of a vehicle model on a display device during vehicle driving, according to an embodiment of the present invention;

FIG. 10 is a flowchart illustrating a vehicle chassis operation visualization method according to an embodiment of the present invention;

FIG. 11 is a flowchart illustrating a method for visualizing an operation of a brake device of a vehicle according to an embodiment of the present invention;

### DETAILED DESCRIPTION

Throughout the specification, the same reference numerals denote the same components. This specification does not describe all elements of the embodiments; common content within the technical field to which the disclosed invention belongs or content overlapping between embodiments is omitted. The terms ‘part, module, component, block’ used in the specification may be implemented in software or hardware. Depending on the embodiments, multiple ‘parts, modules, components, blocks’ may be implemented as a single component, or a single ‘part, module, component, block’ may include multiple components.

Throughout the specification, when a part is said to be ‘connected’ to another part, this includes not only direct connection but also indirect connection, which includes connection via a wireless communication network.

Furthermore, when a part is said to ‘include’ a component, this means it may include other components unless specifically stated otherwise and does not exclude other components.

Throughout the specification, when an element is said to be located “on” another element, this includes not only cases where one element is in contact with another, but also cases where another element exists between the two elements.

Terms such as “first,” “second,” etc., are used to distinguish one component from another and do not limit the components to those specifically named.

Expressions in the singular include the plural unless the context clearly indicates an exception.

In each step, identification codes are used for descriptive convenience. These codes do not describe the sequence of steps, and each step may be performed in a different order from that stated unless a specific sequence is clearly indicated by the context.

The operating principles and embodiments of the disclosed invention are described below with reference to the accompanying drawings.

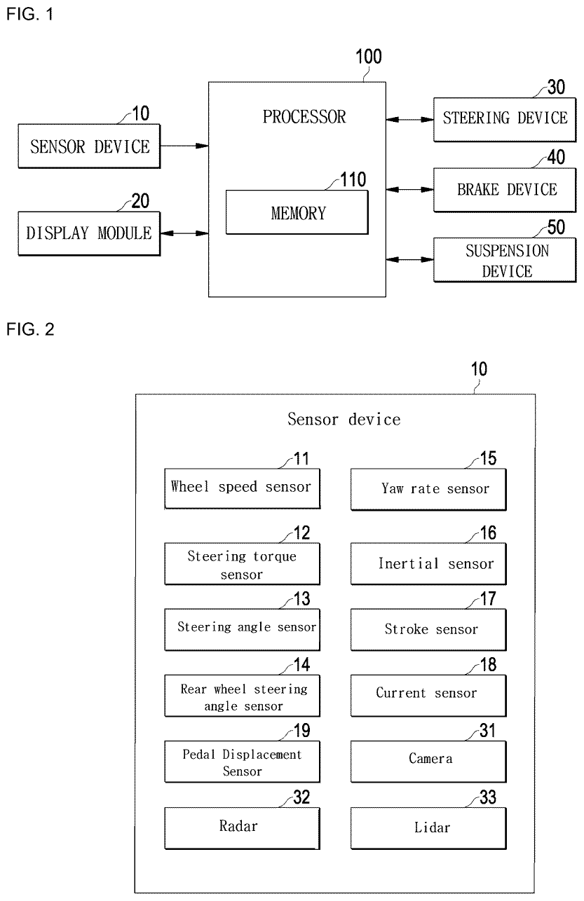

FIG. 1 illustrates the configuration of a vehicle operation visualization device according to one embodiment, and FIG. 2 illustrates the configuration of a sensor device according to one embodiment.

First, referring to FIG. 1, the vehicle operation device according to this embodiment may include a sensor device 10, a display module 20, a steering device 30, a brake device 40, a suspension device 50, and a processor 100. In this specification, the chassis components may be understood to include the steering device 30, the brake device 40, and the suspension device 50.

The sensor device 10 according to this embodiment may correspond to a configuration that detects the state and/or movement (dynamic) of a vehicle to acquire operational information of at least one chassis component, such as the steering device 30, brake device 40, or suspension device 50.

Referring to FIG. 2, the sensor device 10 according to this embodiment may include various types of sensors to acquire real-time operational information of chassis components. For example, the sensor device 10 may include a wheel speed sensor 11 that detects the vehicle's speed, a steering torque sensor 12 that precisely detects the torque applied to the steering wheel by the driver, a steering angle sensor 13 that detects the steering degree of the steering wheel, a rear steering angle sensor 14 that detects the steering angle of the rear wheels during rear-wheel steering, a yaw rate sensor 15 that detects the vehicle's yaw rate, an inertial sensor 16 that measures the vehicle's body inertia and/or wheel inertia, a stroke sensor 17 that detects the vertical displacement of the suspension in real time, a current sensor 18 that detects the drive current flowing to the suspension actuator, and a pedal displacement sensor 19 that detects the pedal input applied to the brake pedal and/or accelerator pedal, comprising at least one of these sensors.

Specifically, the wheel speed sensor 11 may include a permanent magnet that generates a magnetic field and a Hall element that detects changes in the magnetic field. The wheel speed sensor 11 can acquire rotational speed data for each wheel of the vehicle.

The steering torque sensor 12 may include a driver input torque detection section, a system steering force detection section, and a Torque Overlay Processing Module (TOPM). The steering torque sensor 12 can independently measure the driver's steering input and the steering force added by the EPS system, perform summation and calibration of the measured values, and transmit them to the processor 100.

The steering angle sensor 13 may include an encoder disk and an optical detector. The steering angle sensor 13 may correspond to a configuration that measures the vehicle's steering input and acquires steering angle data.

The rear wheel steering angle sensor 14 may include an absolute angle detection unit, a relative angle detection unit, and a steering angle calculation module (SACM). The rear wheel steering angle sensor 14 may correspond to a configuration that detects the absolute steering angle of the rear wheels, calculates the change in steering angle, and transmits precise rear wheel steering angle information to the processor 100 by synthesizing these signals.

The yaw rate sensor 15 may include a vibrating mass and a piezoelectric element. The yaw rate sensor 15 can measure the rotational angular velocity of the vehicle about its vertical axis and acquire rotational motion data of the vehicle.

The inertial sensor 16 may include an IMU sensor and/or a wheel acceleration sensor to detect the vehicle's dynamic behavior. The inertial sensor 16 can detect the vehicle's body inertia using the IMU sensor. The inertial sensor 16 can detect the vehicle's wheel inertia using the wheel acceleration sensor.

The stroke sensor 17 may include a linear displacement detection unit, a temperature compensation unit, and a stroke signal processing module (SSPM). The stroke sensor 17 detects the relative displacement between the vehicle body and the wheel due to the suspension operation of the vehicle and transmits the detected signal to the processor 100.

The current sensor 18 may include a Hall effect current detection unit, a shunt resistance detection unit, and a Current Signal Processing Module (CSPM). The current sensor 18 detects the current value applied to the damper actuator of the suspension device 50 and transmits the detected signal to the processor 100.

The pedal displacement sensor 19 is installed on the rotational axis of the accelerator pedal and/or brake pedal, detects the displacement amount of the pedal to measure the driver's pedal operation amount, and can acquire pedal input data.

However, the number or type of sensors included in the sensor device 10 is not limited to these, and may further include, for example, a camera 31, radar 32, and lidar 33. These can communicate with each other via the vehicle communication network (NT), which is the vehicle's internal communication network. For example, electrical devices included in the vehicle can exchange data using at least one of the communication methods Ethernet, MOST (Media Oriented Systems Transport), Flexray, CAN (Controller Area Network), or LIN (Local Interconnect Network).

Referring again to FIG. 1, the display module 20 may correspond to a configuration that provides the driver with various information and entertainment through video and audio. The display module 20 may include a cluster, a head-up display, a center fascia monitor, a head unit, a passenger display, and rear seat entertainment (RSE). The display module 20 may include a touch display capable of user touch operation.

The display module 20 according to this embodiment can provide the driver with graphic information or warning messages based on the operational information of the moving vehicle, using a vehicle model that implements the actual appearance of the vehicle through 3D modeling. That is, the display module 20 can intuitively display the operational status of the chassis components of the moving vehicle via a user interface. For this purpose, the display module 20 may include a separate processor (not shown). The processor may be provided integrally with the display module 20, but is not limited thereto; it may be separately included in the processor 100, and the processor 100 may also perform the role of the processor for the display module 20.

The steering device 30 may correspond to a configuration that changes the vehicle's driving direction according to the driver's steering operation. The steering device 30 may include an Electronic Power Steering (EPS) Control Module or steer-by-wire (SBW), among others.

The brake device 40 may correspond to a configuration that stops the vehicle. The brake device 40 may include, for example, a brake caliper, a drum brake, and/or a Brake Control Module (EBCM).

The suspension device 50 may correspond to a configuration that ensures driving stability and improves ride comfort. The suspension device 50 may include, for example, springs, dampers, air suspension, and an Electronic Damping Control Module (EDCM). The Electronic Damping Control Module may correspond to a configuration that absorbs shocks transmitted from the road surface through the action of springs and dampers or controls the vehicle's posture. Furthermore, the Electronic Damping Control Module can control the damping force of the shock absorber in response to requests from the processor 100 based on driving conditions.

The processor 100 according to this embodiment may correspond to an entity that generates graphical information for visually representing the state of a chassis component by inputting operational information of at least one chassis component, such as the vehicle's steering device 30, brake device 40, and suspension device 50.

To this end, the processor 100 can acquire the operational information of the chassis component via at least one of an external device (not shown) and the vehicle's internal sensor 10. In this case, the processor 100 can receive the operational information input via at least one of the communication methods: CAN, LIN, FlexRay, or Ethernet. Using the operational information acquired via the vehicle communication network, the processor 100 can generate graphical information for visually representing at least one of the vehicle's steering status information, brake status information, or suspension status information.

The processor 100 can reflect the generated graphic information onto a vehicle model that visually represents the vehicle body and the vehicle's chassis components. The vehicle model may include the three-dimensional shape of the vehicle body and the three-dimensional shapes of the chassis components contained within the vehicle. That is, the vehicle model may correspond to a configuration implemented through multidimensional modeling, enabling the integrated visualization of the operational state, physical characteristics, and state changes of the vehicle or each chassis component contained within the vehicle over time. Therefore, the vehicle model in this specification may refer to a dynamic visualization model designed to precisely reflect the actual operation and state of the vehicle, rather than a simple static 3D model.

The vehicle body shape may vary depending on the vehicle type, so the exterior appearance of the vehicle model may correspond to a configuration adjusted according to the specific vehicle type. For example, the overall silhouette, wheel arrangement, and body height may differ for vehicle types such as SUVs, sedans, and hatchbacks. This vehicle class information may be pre-stored in the memory 110 or received from an external server (e.g., manufacturer server, vehicle remote control server) via the vehicle's network system. The processor 100 can select the corresponding exterior information based on the received or stored vehicle class information and apply it to the vehicle model.

The processor 100 may include a memory 110. The memory 110 may correspond to a configuration for storing programs and/or data for displaying graphical information about the vehicle model. The memory 110 may temporarily store operational information of chassis components received from a plurality of sensors included in the sensor device 10. Furthermore, the memory 110 may temporarily store processing results of chassis data received from the plurality of sensors included in the sensor device 10 by the processor 100. The memory 110 may include volatile memory such as S-RAM (Static Random Access Memory) and D-RAM (Dynamic Random Access Memory), as well as non-volatile memory such as flash memory, ROM (Read-Only Memory), and EPROM (Erasable Programmable Read-Only Memory).

The processor 100 may transmit a communication signal to the display module 20 to display the generated graphic information on the vehicle model. For example, the processor 100 may transmit a communication signal to the display module 20 to visually display graphic information for at least one of the vehicle's steering status information, brake status information, or suspension status information on the vehicle model, based on the operation information of the chassis components.

To this end, the processor 100 can identify the vehicle's driving state based on the operational information of the chassis components received from the sensor device 10. Here, the driving state may include not only the vehicle's physical state, such as speed, acceleration, yaw rate, steering angle, powertrain force, and brake force, but also driving modes such as straight driving, cornering, acceleration, braking, and driving on an incline, as well as the vehicle's attitude control state, such as normal driving, slip occurrence, understeer, and oversteer.

The processor 100 can generate graphic information that visually represents status information regarding the steering device 30, brake device 40, and/or suspension device 50 based on the operational information of the chassis components, and transmit a communication signal to the display module 20 to reflect this on the vehicle model. To this end, the processor 100 may include a micro control unit (MCU) that generates a display signal to display the graphic information visually representing the operational state of the chassis components as motion graphics on the vehicle model.

The processor 100 can generate graphic information by adjusting one or more graphic elements for the chassis components of the vehicle model or for a portion of the vehicle model's body. These graphic elements may include at least one of transparency, outline, surface color, gloss, shading, size, or animation effects.

More specifically, the processor 100 can render the vehicle body partially translucent to enable the user to observe the chassis components inside the vehicle model more clearly. For example, when it is necessary to emphasize the operational state of any one of the steering device 30, brake device 40, and suspension device 50, the processor 100 can increase the transparency of the corresponding body section to visualize the internal structure so that it is identifiable from the outside.

The processor 100 can adjust graphic elements such as the outline, surface color, or thickness of a specific chassis component to emphasize its position or shape.

The processor 100 can enhance visual realism or achieve emphasis effects on specific areas by adjusting the glossiness or contrast of surfaces. For example, the processor 100 can convey the texture or depth perception of chassis components to the user through techniques such as reflective light rendering or shading.

Additionally, the processor 100 can temporarily alter the size of specific chassis components to emphasize their operational status or importance. For example, the processor 100 can change the viewpoint of the vehicle model based on user input. The processor 100 can also control the display module 20 to perform actions such as rotating, zooming in, or zooming out the vehicle model. This viewpoint control functionality enables the user to observe specific areas of the chassis components from various angles and more precisely verify the status of chassis components of interest.

The processor 100 can apply animation effects to dynamically represent the operational state of the chassis components. For example, the processor 100 can implement animations that reflect in real time the steering angle of the steering device 30, the operational status of the brake device 40, and the vertical movement of the suspension device 50, thereby enabling the user to understand the vehicle's operational state more intuitively.

Adjustment of graphic elements by the processor 100 can be implemented through a multidimensional modeling-based vehicle model that incorporates physical changes over time and state information, extending beyond simple 3D modeling. That is, the vehicle model enables integrated visualization not only of the vehicle's exterior but also of the dynamic behavior and state changes of each chassis component.

The processor 100 can continuously monitor the operational information of the chassis components. If information exceeding a pre-set threshold criterion is received among the operational information of the chassis components, the processor 100 can generate an audible alarm or a visual warning via graphical information regarding the operational status of the corresponding chassis component. For this purpose, the memory 110 may store one or more threshold criteria defining the normal operating range for each chassis component. These threshold criteria may include, for example, cases where the steering angle changes abruptly, the braking pressure rises abnormally, or the stroke length of the suspension device 50 exceeds a set limit.

The processor 100 can provide a warning to immediately alert the driver to the potential abnormal operation of the chassis component if the received operational information exceeds any of these preset threshold criteria. The warning can be provided not only as an audible alert output through the vehicle's speakers but also visually by overlaying graphic information onto the vehicle model. For example, the processor 100 can highlight the abnormal chassis component with a red outline or add a flashing icon or animation effect to that area, enabling the driver to intuitively recognize the location of the abnormality and its severity. In cases where multiple chassis components simultaneously exceed critical thresholds, the processor 100 may prioritize warnings based on importance or risk level, and implement examples where visual warning information is output sequentially or simultaneously.

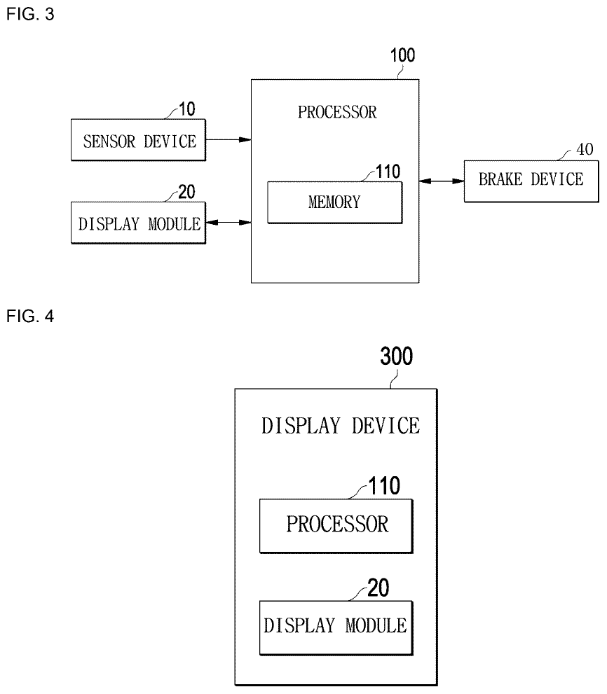

FIG. 3 is a block diagram illustrating a configuration for display and control of a brake device 40 according to an embodiment of the present invention. Hereinafter, based on the foregoing description, a detailed explanation will be given regarding the generation of graphic information specifically related to the brake device 40, which is one of the chassis components.

Referring to FIG. 3, in relation to at least one of information display or control of the brake device 40, the processor 100 may receive operation information of the brake device 40 from the sensor device 10 to identify a brake state.

The processor 100 may detect a slip state and posture of the vehicle based on data received from the sensor device 10, such as a wheel speed sensor 11, a yaw rate sensor 15, and/or an inertial sensor 16. The processor 100 may control a vehicle stability control system including an Anti-lock Brake System (ABS), Electronic Stability Control (ESC), and Traction Control System (TCS).

The processor 100 may set a chassis control mode for controlling the brake device 40 using a predefined brake function—such as regenerative braking, low-friction surface braking, or electronic brakeforce distribution—based on either an automatic setting or a driver input received via the display module 20. The processor 100 may transmit a communication signal to the display module 20 to visually display, on the vehicle model, graphic information including brake state information, based on the chassis control mode. The brake state information may include at least one of a chassis motion of the brake device 40 or an identified driving condition.

The processor 100 may update, in real time, graphic information of the vehicle model displayed via the display module 20 based on an operational state of the brake device 40. Additionally, the processor 100 may automatically adjust a transparency of the vehicle body to more clearly indicate brake state information, or may transmit a communication signal to the display module 20 to change the transparency of the vehicle body based on user input.

The processor 100 may visualize differences between a predefined brake function being activated and deactivated. For example, during braking, the current vehicle speed and estimated stopping distance may be displayed in numerical or graphic form. In the case of ABS activation, the processor 100 may emphasize the shortened braking distance compared to when ABS is not active. Alternatively, the processor 100 may compare the estimated braking distance with the actual braking distance and reflect the improvement in braking performance of the brake device 40 on the contact surface of the vehicle model. When ESC is active, the processor 100 may display the traveling direction and the target direction of the vehicle on the vehicle model using arrows, and may visualize the path correction effect resulting from control intervention. In the case of TCS activation, a gauge-type graphic may be displayed to indicate a reduction in wheel slip ratio and the resulting improvement in traction. The processor 100 may reflect a graphic element indicating the level of traction enhancement on the driven wheels of the vehicle model based on the TCS activation state. In addition, the processor 100 may reflect a graphic element representing a braking trajectory on a rear floor surface of the vehicle model. Through this, the processor 100 may generate a visual effect related to at least one of a braking force intensity or a braking duration of the brake device 40.

The processor 100 may transmit a communication signal to the display module 20 to highlight the fault identification section in the vehicle model when a fault in the brake device 40 is identified.

The processor 100 may receive a driver's control input through a touch interface of the display module 20. Based on the driver's control input, the processor 100 may perform at least one of a viewpoint change, rotation, zoom-in, or zoom-out of the vehicle model to display brake state information in more detail.

The processor 100 may transmit a communication signal to the display module 20 to display an identified brake state based on a predefined brake function. The processor 100 may also set and/or modify a brake parameter related to the predefined brake function based on a driver's control input received through a touch interface of the display module 20. Here, the brake parameter may be a predefined setting value that is mapped and stored as mapping data in a memory 110, based on operation or actuation of the brake device 40.

The processor 100 may adjust graphic elements of each wheel of the vehicle model based on operation information reflecting braking response characteristics of the brake device 40, wherein the graphic elements may include at least one of brake temperature, wear state, brake force distribution, and pedal input intensity. For example, when a temperature of a brake pad rises above a certain threshold, the processor 100 may emphasize the corresponding wheel's graphic element in a red tone for display on the vehicle model. When the wear state approaches a critical threshold, the processor 100 may visually issue a warning by changing an outline thickness or transparency of the corresponding wheel. The brake force distribution for each wheel may be visually emphasized by adjusting a thickness or length of indicator bars corresponding to each wheel. Additionally, the processor 100 may enhance the realism of the braking situation by applying animation effects such as vehicle body tilt or deceleration response, which vary depending on the intensity of the driver's pedal input.

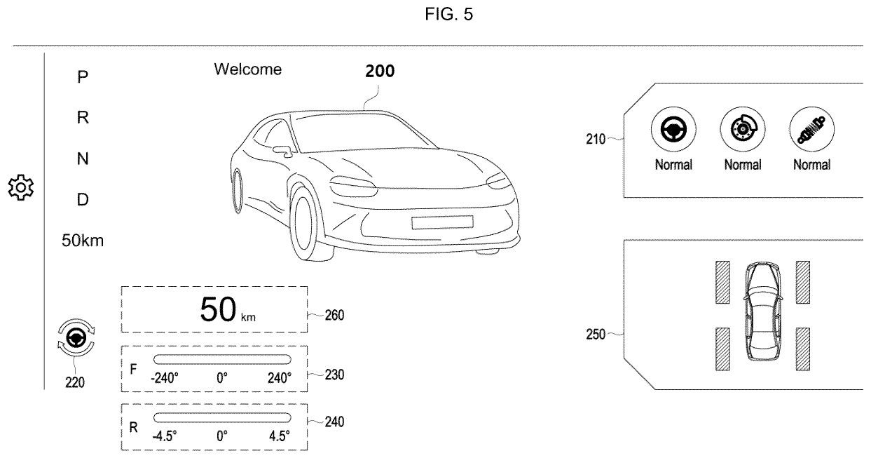

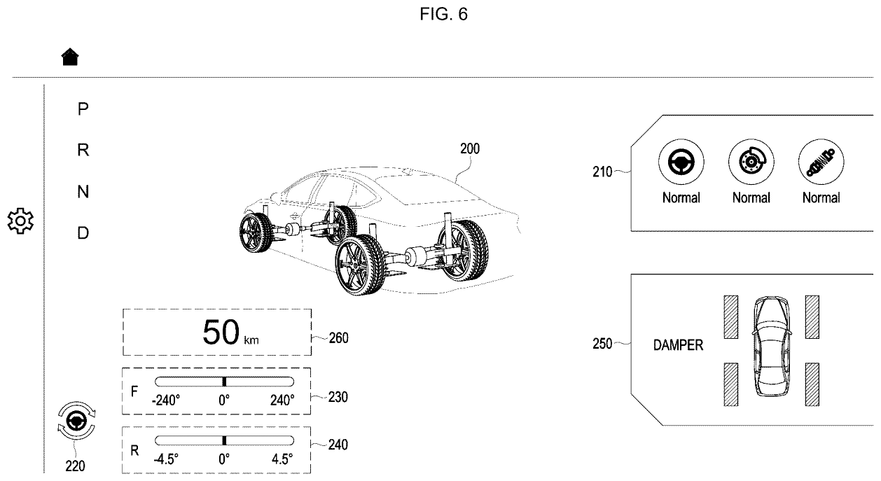

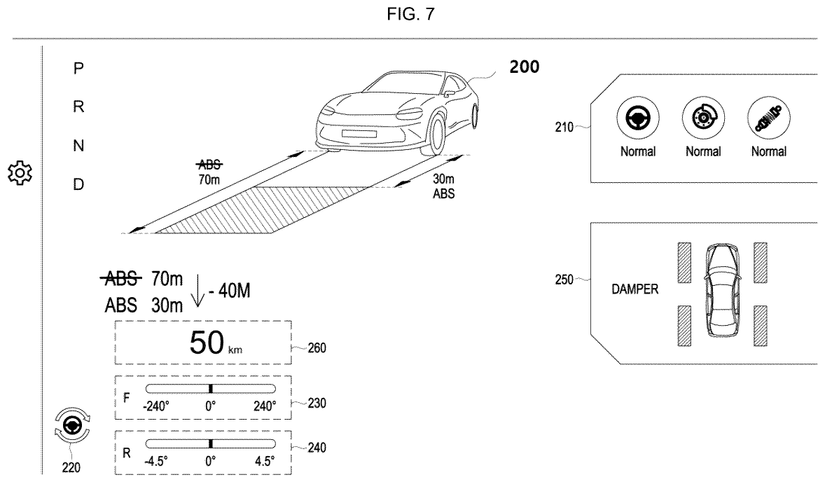

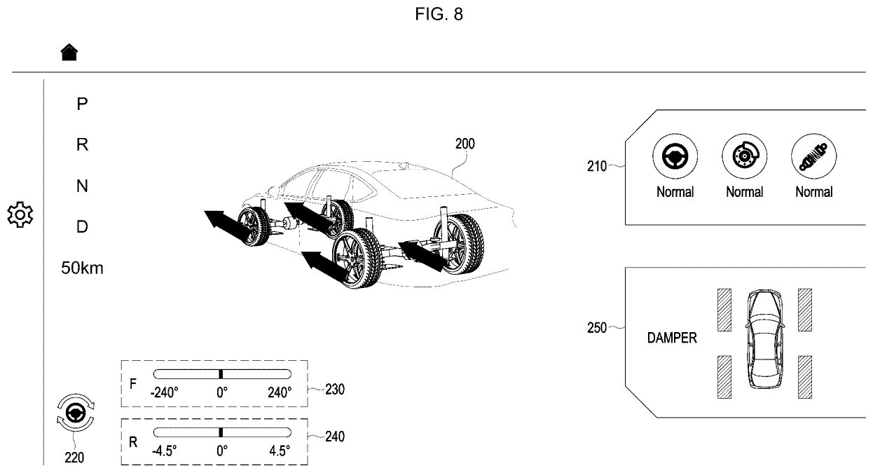

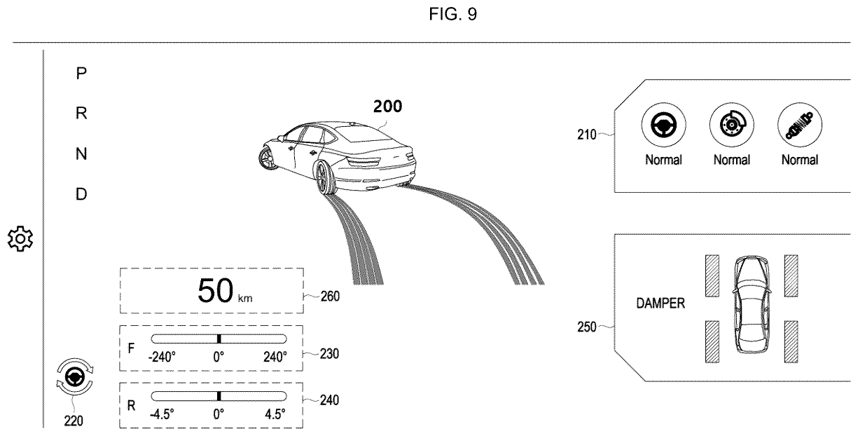

FIG. 4 is a block diagram illustrating the configuration of a display device according to another embodiment, FIG. 5 illustrates an initial screen provided in a user interface displayed on the display device during driving of a vehicle, according to another embodiment, FIG. 6 illustrates a user interface that intuitively indicates a brake operation state according to an embodiment of the present invention, FIGS. 7 and 8 illustrate user interfaces that intuitively indicate, respectively, an ABS operation state and a TCS operation state on a display device during vehicle driving, according to an embodiment of the present invention, and FIG. 9 illustrates a user interface that intuitively indicates a visual effect of a vehicle model on a display device during vehicle driving, according to an embodiment of the present invention.

Hereinafter, with reference to FIGS. 4 through 9, a detailed description will be given of the generation of graphic information based on operation information of the brake device 40, and its application to the vehicle model 200, according to an embodiment of the present invention.

Referring first to FIG. 4, the display device 300 according to an embodiment of the present invention may include a processor 100 and a display module 20.

The display device 300 may be configured to visually output, via the display module 20, graphic information acquired or generated by the processor 100. The configurations and operations of the processor 100 and the display module 20 included in the display device 300 are substantially the same as those described above with respect to the vehicle chassis operation visualization apparatus, and redundant descriptions will thus be omitted. That is, the display device 300 may be understood as an embodiment having the same technical configuration as the aforementioned vehicle operation visualization device, but with a focus on the hardware category performing the output function.

Referring to FIG. 5, the initial screen of the display device 300 may include a user interface for providing driving information, including the vehicle model 200 and the operational status of chassis components.

As shown in FIG. 5, the user interface on the initial screen displays the vehicle model 200, chassis setting indicator 210, steering wheel indicator 220, front wheel steering indicator 230, rear wheel steering indicator 240, suspension indicator 250, and speed indicator 260. To this end, the processor 100 may retrieve the last chassis control mode stored in the memory 110 from the previous drive and display it on the display module 20.

The chassis setting indicator 210 may correspond to a configuration that clearly displays, with text, which mode each of the steering, brakes, and suspension is set to. Specifically, the chassis setting indicator 210 may provide a user interface for manipulating the chassis control mode of the steering, brakes, or suspension. For example, when the driver selects one of Normal, Comfort, or Sport, the chassis setting indicator 210 may set the initial values for each chassis component according to the driver's selected mode.

The steering indicator 220 may be configured to provide an animated rotation based on the driver's steering wheel operation status.

The front wheel steering indicator 230 may include a graphic element that can display the actual steering state of the front wheels based on the driver's steering wheel operation, and can display it intuitively in real time according to the steering state of the front wheels.

The rear wheel steering indicator 240 may include a graphic element that can display the steering state of the rear wheels when rear wheel steering is occurring, and can display it intuitively in real time based on the steering state of the rear wheels.

The suspension indicator 250 may include a graphic element configured to display suspension stress (damping force) applied to each wheel, for example, when passing over an uneven road surface or when damping occurs in the suspension device 50. The processor 100 may visually indicate the real-time suspension state of each wheel more intuitively through the suspension indicator 250. To this end, the processor 100 may provide a control signal to the display module 20 to dynamically display changes in the damping force on the suspension indicator 250, based on the calculated suspension stress.

Referring to FIG. 6, the processor 100 may adjust graphic elements of each wheel of the vehicle model 200 based on operation information of the brake device 40, and may increase a transparency of the body of the vehicle model 200 so that the braking state of each wheel can be visually identified.

As shown in FIG. 6, the processor 100 may intuitively display various brake states of the vehicle to the driver via the display module 20. For example, during ABS operation, the processor 100 may visualize the braking performance improvement of ABS by comparing an estimated braking distance with an actual braking distance and displaying the result on the display module 20. Additionally, during ESC operation, the processor 100 may intuitively express the stability control effect by overlaying a target path and an actual driving path of the vehicle on the display. During TCS operation, the processor 100 may visualize the level of traction improvement through a graphic element.

To this end, the processor 100 may identify a brake state based on data received from a pedal displacement sensor 19 and a wheel speed sensor 11 included in the brake device 40, and may generate a control signal for displaying the brake state on the display module 20. The processor 100 may receive data corresponding to an amount of depression of a brake pedal from a pedal displacement sensor 19, and may receive rotation speeds of individual wheels from a wheel speed sensor 11, to compute a brake state. The computed brake state may be visualized through a speed icon on the display module 20, and the display form of the icon may be dynamically changed according to the magnitude of the braking force.

Referring to FIG. 7, the processor 100 may visualize the braking performance improvement of ABS by displaying, on the display module 20, graphic information for comparing an estimated braking distance with an actual braking distance during ABS operation. Specifically, the processor 100 may reflect, on a contact surface of the vehicle model 200, a graphic element indicating the improvement in braking performance of the brake device 40, by comparing the estimated braking distance with the actual braking distance. For example, as shown in FIG. 7, the estimated braking distance in a state where ABS is not applied may be displayed as 70 meters, while the actual braking distance in the current state where ABS is operating may be displayed as 30 meters. The processor 100 may display, as an intuitive graphic element, that the actual braking distance has been reduced by 40 meters due to ABS operation. However, the user interface related to the ABS operation state illustrated in FIG. 7 is merely an example, and any type of graphic element or motion that intuitively conveys the ABS operation state may be used.

Referring to FIG. 8, the processor 100 may visualize the degree of traction improvement during TCS operation through a graphic element. As shown in FIG. 8, during TCS operation, the processor 100 may reflect, on the vehicle model 200, a graphic element that visually represents the degree of traction improvement in the form of an arrow, along with a text element indicating that TCS is active. The user interface related to the TCS operation state illustrated in FIG. 8 is merely an example. For instance, a reduction in slip ratio of the driven wheels may be displayed in the form of a gauge. Likewise, any graphic element or motion that can intuitively convey the TCS operation state may be used.

Referring to FIG. 9, the processor 100 may generate graphic information corresponding to a braking event of the vehicle based on brake state information. Specifically, the processor 100 may reflect a graphic element representing a braking trajectory on a rear floor surface of the vehicle model, thereby generating a visual effect corresponding to at least one of a braking intensity or a braking duration of the brake device 40. The trajectory displayed at the rear of the vehicle model 200 may serve as a visual representation corresponding to an actual braking situation. The braking trajectory may be implemented, for example, in the form of a black or gray semicircular line, or a visual trace resembling a tire skid mark. The processor 100 may dynamically adjust, in real time, the length, thickness, and color density of the braking trajectory based on the braking duration from the initial braking time to the current moment, or based on the pedal input intensity.

In addition to the graphic elements described above, various other graphic elements may be displayed on the display device 300, including a home icon for returning to the initial screen, a settings icon for configuring various options, a gear icon for indicating the gear state, a speed icon for indicating the vehicle's driving speed, and graphic elements for changing the viewpoint, rotating, zooming in or out of the vehicle model 200. Accordingly, it will be apparent to those skilled in the art that various other graphic elements, not explicitly described in the present specification, may be included in the present embodiment, so long as they are capable of expressing the behavior of the vehicle or the operation of chassis components.

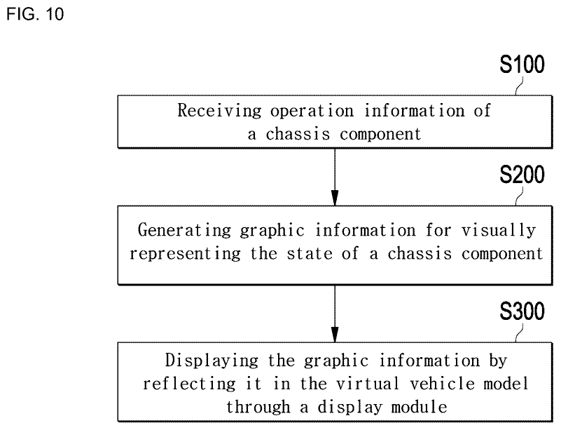

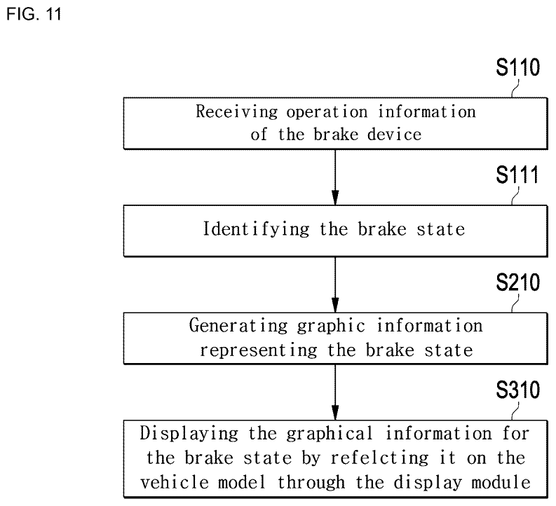

FIG. 10 is a flowchart illustrating a vehicle chassis operation visualization method according to an embodiment of the present invention, and FIG. 11 is a flowchart illustrating a method for visualizing an operation of a brake device of a vehicle according to an embodiment of the present invention.

Hereinafter, the vehicle operation visualization method of the present embodiment will be described with reference to FIG. 10 and FIG. 11. Specific descriptions of parts overlapping with the aforementioned content will be omitted, and the explanation will focus on the chronological structure. The subject of each step of the vehicle operation visualization method according to an embodiment of the present invention may correspond to the processor 100. That is, the vehicle operation visualization method of the present invention corresponds to a series of control operations automatically executed by the processor 100 in conjunction with the sensor device 10, display module 20, and chassis components (30 to 50), rather than actions performed directly by a person. Therefore, the following description will focus on the actions performed by the processor 100 to explain each step.

Referring to FIG. 10, the vehicle operation visualization method comprises: step (S100) of receiving operation information of at least one chassis component from among the steering device 30, brake device 40, and suspension device 50; a step (S200) of generating graphic information for visually representing the state of the chassis component based on the input operation information, and a step (S300) of reflecting the graphic information onto a vehicle model that visually represents the vehicle body or chassis component and outputting it via a display module 20.

Specifically, the processor 100 can receive chassis component operation information from at least one of an external device and the vehicle's internal sensor device 10. For this purpose, the processor 100 can utilize at least one of the communication methods CAN, LIN, FlexRay, or Ethernet. The received operational information may include the current operational status of each chassis component, such as steering angle, brake pressure, and suspension compression/rebound amount (S100).

Subsequently, the processor 100 may generate graphic information to visually represent the state of the chassis components based on the input motion information. The generated graphic information may include visual elements not only to depict the vehicle's exterior but also to intuitively convey the dynamic behavior and state changes of each chassis component within the vehicle.

The processor 100 can generate the graphical information by adjusting one or more graphical elements for the chassis components of the vehicle model 200 or for a specific area of the vehicle body of the vehicle model 200. The vehicle model 200 can be implemented as a three-dimensional or multi-dimensional model that includes the vehicle's exterior and chassis components. The graphic elements may include at least one of transparency, outlines, surface color, gloss, shading, size, or animation effects.

The processor 100 may display a warning color or a visual emphasis effect on the display based on a state change of a chassis component being equal to or greater than a preset threshold. For example, the processor 100 may generate graphic information indicating the direction of a wheel according to a change in the steering angle, or apply a red highlight to the corresponding wheel of the vehicle model 200 by adjusting a graphic element when the brake pressure exceeds the threshold.

The processor 100 may also change the transparency of the vehicle model 200 so that the model becomes transparent, based on the state change of the chassis component being equal to or greater than a preset threshold. Subsequently, when the state change of the chassis component is restored to less than the preset threshold, the processor 100 may change the transparency of the vehicle model 200 so that it becomes opaque again.

Alternatively, the processor 100 may display a chassis model of the chassis component based on a state change of the chassis component being equal to or greater than a preset threshold. Subsequently, when the state change of the chassis component is restored to less than the preset threshold, the processor 100 may remove the chassis model of the chassis component (S200).

The processor 100 can reflect the graphic information onto a vehicle model 200 that visually represents the vehicle body or chassis components and output it via a display module 20. In doing so, the processor 100 can precisely map the generated graphic information to the corresponding location and area of the vehicle model 200, thereby matching the real-time changing vehicle state to the vehicle model 200. The display module 20 can visually output the primary operational states of vehicle chassis components, such as the steering device 30, brake device 40, and suspension device 50, through this graphic information.

Meanwhile, when motion information exceeding a preset threshold is received, the processor 100 may output an audible warning or a visual warning via graphical information regarding the operational status of the chassis component. The threshold criteria may be defined as conditions deviating from pre-set normal ranges for each chassis component, such as sudden changes in steering angle, abnormal increases in brake pressure, or excessive displacement of suspension stroke.

The processor 100 may provide an audible alert via a warning tone or generate a visual warning using graphic information when the condition is satisfied. The visual warning may be implemented by highlighting the location of the abnormality on the vehicle model 200, or through forms such as flashing, color changes, or icon displays. For example, if the brake temperature exceeds the limit value, the corresponding wheel may be displayed flashing red or an overlay warning icon may be displayed to enable the driver to immediately recognize the location of the abnormality (S300).

Referring to FIG. 11, a brake device 40 operation visualization method according to an embodiment of the present invention may include: a step (S110) of receiving operation information of the brake device 40; a step (S111) of identifying a brake state based on the received operation information of the brake device 40; a step (S210) of generating graphic information corresponding to the identified brake state; and a step (S310) of reflecting the generated graphic information on a vehicle model 200 and outputting it via the display module 20.

Specifically, the processor 100 may receive operation information of the brake device 40. The operation information may be collected from various sensors included in the brake system. For example, the operation information may include physical or electrical data such as pedal actuation intensity, braking pressure, brake disc temperature, wear status, and braking force distribution. The processor 100 may receive the operation information, which is updated at predetermined intervals (e.g., less than 100 ms), via an in-vehicle Controller Area Network (CAN) (S110).

Based on the input operation information, the processor 100 may identify the current state of the brake device 40. The brake state may include, for example, whether braking is being applied (ON/OFF), braking intensity, braking duration, braking balance (distribution between front/rear or left/right wheels), and whether ABS or TCS is activated. The processor 100 may perform an integrated analysis of multiple input data, and may determine that a braking state exists if the detected braking intensity exceeds a predefined threshold. In addition, the processor 100 may estimate how deeply and how long the driver pressed the brake pedal based on a continuous variation pattern of the braking intensity (S111).

Subsequently, the processor 100 may generate graphic information related to the brake state. The graphic information is intended to visually represent information about the braking condition of the brake device 40, and may include graphic elements such as numerical values, graphs, colors, or a combination thereof. For example, when the braking intensity is high, the processor 100 may generate a darker color or a longer braking trace, and when the braking duration is long, the processor 100 may increase the length or thickness of the braking trace. Additionally, when an auxiliary braking system such as ABS or TCS is activated, the processor 100 may generate corresponding graphic information. The generated graphic information may be superimposed onto the vehicle model in a subsequent step and displayed through the display module 20 (S210).

The processor 100 may adjust graphic elements of each wheel of the vehicle model 200 based on the operating information of the brake device 40. For example, the processor 100 may increase the transparency of the vehicle body of the vehicle model 200 such that the brake state of each wheel is visually identifiable.

The processor 100 may adjust the graphic elements of each wheel of the vehicle model 200 based on the operation information of the brake device 40. For example, if the temperature of the brake device 40 exceeds a certain threshold, the processor 100 may gradually change the color of the corresponding wheel to a red tone, or adjust the color saturation or transparency according to the degree of thermal degradation. Alternatively, if the wear level of the brake pad exceeds a predefined limit, the processor 100 may place a warning icon near the corresponding wheel or add a blinking effect to the rotating graphic to indicate the abnormal condition. Such wear information may be received from a wear sensor or via self-diagnostic results of the associated braking system. If the brake force distribution is unbalanced between left and right or front and rear wheels, the processor 100 may output asymmetrical visual effects, such as varying brightness or compression graphics on the wheels of the vehicle model 200. Through this, the processor 100 may highlight the wheels with concentrated brake force to allow the driver to recognize the imbalance.

If the pedal input intensity is strong or a sudden braking situation is detected, the processor 100 may generate graphic information including an animation in which the wheel graphics temporarily switch to a stopped state from high-speed rotation, or a graphic pattern indicating emergency braking is added to the vehicle's trajectory.

When ABS is activated, the processor 100 may reflect a graphic element on the ground surface of the vehicle model 200 that indicates the enhanced braking performance of the brake device 40 by comparing the expected braking distance with the actual braking distance. Specifically, when strong brake pedal input is detected and braking is maintained without wheel lock-up, the processor 100 may compare the predicted braking distance based on the current speed and road surface condition with the actual stopping distance of the vehicle. To achieve this, the processor 100 may estimate the road surface condition and visually change the vehicle model 200's ground or body to reflect the estimated condition. The processor 100 may analyze the difference between the expected and actual braking distances and visually highlight the degree of braking performance improvement. For example, the processor 100 may dynamically display a graphic element in blue or green tones (e.g., a bar representing the shortened distance) on the contact surface of the vehicle model 200 to symbolize the reduction in braking distance achieved through ABS control.

When TCS is activated, the processor 100 may apply a graphic element to the corresponding wheel of the vehicle model 200 to visually represent the degree of traction improvement resulting from TCS operation. For example, when the vehicle rapidly accelerates or climbs an inclined road on a low-friction surface (e.g., wet or snowy roads), TCS may be activated if slip is detected on a specific wheel. In such a case, the processor 100 may generate visual effects for the corresponding wheel to indicate traction recovery or drive force control status—such as a blinking traction icon over the tire or an anti-slip animation. Furthermore, the processor 100 may represent the degree of traction enhancement using numerical indicators or color variations, thereby allowing the driver to instantly recognize which wheel is being controlled and to what extent in real time.

The processor 100 can generate a visual effect for at least one of the braking intensity and duration of the brake device 40 by reflecting a graphic element indicating the braking trajectory on the rear floor surface of the vehicle model 200. Specifically, when braking intensity is high, a dark-colored braking trajectory line may be output on the rear ground area of the vehicle model 200, and the length of the trajectory may increase as braking continues. Conversely, for short or weak braking, a short, faint trajectory may be displayed on the rear ground area of the vehicle model 200. This trajectory virtually replicates the actual brake marks left on the road surface, allowing the driver to observe their braking habits or frequency of sudden braking in real time through the virtual model (S210).

The processor 100 can reflect the generated graphic information onto the vehicle model 200 and output it via the display module 20. Specifically, the processor 100 can generate visual elements based on each wheel's braking force, brake temperature, wear status, or braking duration, and output them graphically around the corresponding wheel. Alternatively, when the processor 100 detects an imbalance in the braking force distribution of the brake device 40 or excessive braking duration, it can add visual effects such as color changes or transparency changes to the wheels or contact surfaces of the vehicle model 200, thereby reflecting the brake status in real time (S310).

As described above, The vehicle operation visualization device, method, and display device according to an embodiment of the present invention can align the ride comfort and visual experience of the driver and/or passengers, provide satisfaction, and naturally induce purchases of higher-end products or FoD (Feature On Demand) subscriptions, etc., by visualizing and displaying operation information, including the chassis operating status of the vehicle during driving, through an intuitive user interface.

Meanwhile, the disclosed embodiments may be implemented in the form of a recording medium storing computer-executable instructions. The instructions may be stored in the form of program code, and when executed by a processor, may generate a program module to perform the operations of the disclosed embodiments. The recording medium may be implemented as a computer-readable recording medium.

Computer-readable storage media includes any type of storage medium on which instructions decodable by a computer are stored. Examples include ROM (Read-Only Memory), RAM (Random Access Memory), magnetic tape, magnetic disk, flash memory, optical data storage devices, and the like.

Storage media readable by a device may be provided in the form of non-transitory storage media. Here, ‘non-transitory’ merely means that the storage medium is a tangible device and does not contain a signal (e.g., an electromagnetic wave). This term does not distinguish between cases where data is stored semi-permanently on the storage medium and cases where it is stored temporarily. For example, a ‘non-transitory storage medium’ may include a buffer where data is stored temporarily.

The embodiments disclosed herein have been described with reference to the accompanying drawings. Those skilled in the art to which the present invention pertains will understand that the invention may be practiced in forms different from the disclosed embodiments without changing the technical concept or essential features of the invention. The disclosed embodiments are illustrative and should not be interpreted as limiting.

What is claimed is:

1. A method for visualizing vehicle operation, comprising:
displaying a vehicle model; and
changing at least one graphic element of the vehicle model to visually represent a state change of a chassis component of the vehicle, including a brake device, based on operation information reflecting braking response characteristics of the chassis component,
wherein the operation information includes at least one of a braking force of the brake device, a brake pressure, or a displacement of a brake pedal.

2. The method of claim 1, wherein the graphic element includes at least one of transparency, color, brightness, contrast, or an animation effect.

3. The method of claim 2, wherein the state change of the chassis component includes at least one of a steering angle of a steering device, a braking force of the brake device, or a stroke amount of a suspension device.

4. The method of claim 1, wherein a warning color or a visual emphasis effect is displayed on the display based on the state change of the chassis component being equal to or greater than a preset threshold.

5. The method of claim 1, wherein the act of changing at least one graphic element of the vehicle model for display includes changing a transparency of the vehicle model so that the vehicle model becomes transparent, based on the state change of the chassis component being equal to or greater than a preset threshold.

6. The method of claim 5, wherein the act of changing at least one graphic element of the vehicle model for display includes changing a transparency of the vehicle model so that the vehicle model becomes opaque, based on the state change of the chassis component being restored to less than the preset threshold.

7. The method of claim 1, wherein the method further comprises displaying a chassis model of the chassis component based on the state change of the chassis component being equal to or greater than a preset threshold.

8. The method of claim 1, wherein the method further comprises removing a chassis model of the chassis component based on the state change of the chassis component being restored to less than a preset threshold.

9. The method of claim 1, wherein the method further comprises:
acquiring operation data from at least one chassis component among a steering device, a brake device, and a suspension device of the vehicle; and
generating operation information of the at least one chassis component based on the operation data.

10. The method of claim 1, wherein a road surface condition of the vehicle is estimated, and
a visual effect of a floor surface or a portion of a vehicle body of the vehicle model is changed and displayed in response to the estimated road surface condition.

11. The method of claim 1, wherein, in response to the braking force of the brake device, the graphic element for visually indicating a braking state on each wheel of the vehicle model is represented by at least one of a color change, brightness adjustment, or light-emitting animation.

12. The method of claim 11, wherein, based on the braking force of the brake device being equal to or greater than a preset threshold, a warning color or blinking effect is displayed on a corresponding wheel of the vehicle model.

13. The method of claim 11, wherein, in response to a braking force distribution of the brake device, a difference in braking force between front and rear wheels is visually distinguished and displayed on the vehicle model.

14. The method of claim 11, wherein, based on a state in which a braking force control system of the brake device corresponds to an operational state of at least one of ABS, ESC, or TCS, a predefined warning graphic element is displayed on a corresponding wheel or body region of the vehicle model.

15. A vehicle chassis operation visualization apparatus comprising:
a memory; and
a processor connected to the memory, wherein the processor is configured to:
display a vehicle model; and
change at least one graphic element of the vehicle model to visually indicate a state change of a chassis component of the vehicle, including a brake device, based on operation information reflecting braking response characteristics of the chassis component.

16. The apparatus of claim 15, wherein the operation information includes at least one of a braking force, a brake pressure, or a brake pedal displacement of the brake device.

17. The apparatus of claim 15, wherein the processor is configured to visually indicate the state change of the chassis component by changing at least one of transparency, color, brightness, contrast, or an animation effect of the graphic element.

18. The apparatus of claim 15, wherein the processor is configured to change the graphic element based on at least one of a steering angle of the steering device, a braking force of a brake device, or a stroke amount of a suspension device in response to a state change of the chassis component.

19. The apparatus of claim 15, wherein the processor is configured to control a display of a warning color or a visual emphasis effect on the display when the state change of the chassis component is equal to or greater than a preset threshold.

20. A display device for displaying a vehicle model,
wherein the display device is configured to:
change at least one graphic element of the vehicle model to visually indicate a state change of a chassis component of the vehicle, including a brake device, based on operation information reflecting braking response characteristics of the chassis component,
wherein the operation information includes at least one of a braking force of the brake device, a brake pressure, or a displacement of a brake pedal.
